(19) United States
(12) Patent Application Publication
(10) Pub. No.: US 2023/0020301 A1
(43) Pub. Date: Jan. 19, 2023

(54) SHAVING UNIT HAVING HAIR-CUTTING UNITS WITH FIRST AND SECOND PIVOT AXES

(71) Applicant: KONINKLIJKE PHILIPS N.V., EINDHOVEN (NL)

(72) Inventor: Alwin William DE VRIES, ZUIDLAREN (NL)

(21) Appl. No.: 17/782,293

(22) PCT Filed: Dec. 23, 2020
(86) PCT No.: PCT/EP2020/087839

§ 371 Date: Jun. 3, 2022

(30) Foreign Application Priority Data
Dec. 24, 2019 (EP) 19219679.8

(51) Int. Cl. B26B 19/14; B26B 19/38

(52) U.S. Cl. CPC B26B 19/145; B26B 19/143; B26B 19/3853; B26B 19/146; B26B 19/141

(57) ABSTRACT

A shaving unit (3) for use in a shaving device comprises a supporting member (5) and at least two hair-cutting units (6) connected to the supporting member (5), wherein each hair-cutting unit (6) comprises an external cutting member (10), a skin-supporting member (40) having a skin-supporting surface (41) at least partially surrounding the external cutting member (10), and an internal cutting member (20). Further, in each hair-cutting unit (6), the skin-supporting member (40) is pivotable relative to the supporting member (5) about both a first pivot axis (42) and a second pivot axis (43), independently from the skin-supporting members (40) of the other hair-cutting units (6), wherein the respective pivot axes (42, 43) are perpendicular relative to each other, and wherein a total range of a pivot angle over which the skin-supporting member (40) is pivotable about the second pivot axis (43) is equal to or larger than 15°.

### FIELD OF THE INVENTION

The invention relates to a shaving unit for use in a shaving device, the shaving unit comprising a supporting member and at least two hair-cutting units connected to the supporting member, wherein each hair-cutting unit comprises:

an external cutting member having a plurality of hair-entry openings;

a skin-supporting member having a skin-supporting surface at least partially surrounding the external cutting member;

an internal cutting member which is rotatable relative to the external cutting member about a central axis of the hair-cutting unit and comprises a plurality of hair-cutting elements each having a cutting edge, wherein during rotation of the internal cutting member the cutting edges of the hair-cutting elements follow an annular cutting path having, relative to the central axis, a radially inward circular boundary and a radially outward circular boundary; and

a first pivot axis about which the skin-supporting member is pivotable relative to the supporting member independently from the skin-supporting members of the other hair-cutting units, said first pivot axis extending in a tangential direction relative to the central axis and, seen in an axial direction relative to the central axis, being arranged radially outward of the radially inward circular boundary of the annular cutting path.

The invention further relates to a shaving device having a shaving unit as described here before.

### BACKGROUND OF THE INVENTION

A shaving unit and a shaving device as described in the section Field of the Invention are disclosed in WO 2018/138094 A1. This known shaving unit comprises two hair-cutting units. Each hair-cutting unit comprises a housing supporting the internal cutting member and the external cutting member of the hair-cutting unit. The housing accommodates an individual hair-collecting chamber of the hair-cutting unit which is separate from the hair-collecting chamber of the other hair-cutting unit. The skin-supporting member of each hair-cutting unit is arranged on top of the housing of the respective hair-cutting unit and fully surrounds the external cutting member thereof. The housing of each respective hair-cutting unit, together with the internal cutting member, the external cutting member and the skin-supporting member thereof, is pivotable relative to the supporting member about the first pivot axis independently from the housing of the other hair-cutting unit. The first pivot axes of the two hair-cutting units coincide and are arranged between the external cutting members of the hair-cutting units, as seen in the axial direction relative to the central axes of the hair-cutting units. The supporting member comprises a stationary portion, which can be coupled to the main body of the shaving device, and a movable portion, to which the housings of the two hair-cutting units are connected via a pivot structure defining the coinciding first pivot axes. The movable portion is pivotable relative to the stationary portion about a secondary pivot axis which extends perpendicularly to the coinciding first pivot axes, so that the housings of the two hair-cutting units are jointly pivotable relative to the stationary portion about the secondary pivot axis. The first pivot axes and the secondary pivot axis enable the hair-cutting units to adapt their orientations to local contours of the skin of the user during use of the shaving unit, so that a high degree of contact between the external cutting members and the skin is achieved enabling a good result of the shaving process. A disadvantage of this known shaving unit is that the ability of the skin-supporting surfaces and the external cutting members of the hair-cutting units to adapt their orientations to local contours of the skin is not optimal, so that the contact between the external cutting members and the skin is not always optimal and local pressure peaks may occur between the skin and the external cutting members as well as between the skin and the skin-supporting surfaces.

A shaving unit and a shaving device as described in the section Field of the Invention are also disclosed in EP 2 406 042 B1. This known shaving unit comprises three hair-cutting units. Each hair-cutting unit comprises a housing supporting the internal cutting member and the external cutting member of the hair-cutting unit. The housing accommodates an individual hair-collecting chamber of the hair-cutting unit which is separate from the hair-collecting chambers of the other hair-cutting units. The skin-supporting member of each hair-cutting unit is arranged on top of the housing of the respective hair-cutting unit and fully surrounds the external cutting member thereof. The housing of each respective hair-cutting unit, together with the internal cutting member, the external cutting member and the skin-supporting member thereof, is pivotable relative to the supporting member about the first pivot axis independently from the housing of the other hair-cutting units. The skin-supporting member of each hair-cutting unit is pivotable relative to the housing about a second pivot axis extending parallel to the first pivot axis, and the external cutting member of each hair-cutting unit is pivotable relative to the skin-supporting member about a third pivot axis extending perpendicularly to the first and second pivot axes. The first, second and third pivot axes enable the external cutting members of the hair-cutting units to adapt their orientations to local contours of the skin of the user during use of the shaving unit, so that a high degree of contact between the external cutting members and the skin is achieved enabling a good result of the shaving process. Although in this known shaving unit the ability of the external cutting members of the hair-cutting units to adapt their orientations to local contours of the skin is improved as compared with the shaving unit of WO 2018/138094 A1, also in this known shaving unit the ability of the skin-supporting surfaces of the hair-cutting units to adapt their orientations to local contours of the skin is not optimal, so that local pressure peaks may still occur between the skin and the skin-supporting surfaces. In addition, the pivoting range of the external cutting members relative to the skin-supporting members about the third axes is limited. Furthermore, the use of three different pivot axes for each hair-cutting unit results is a relatively complex structure of this known shaving unit.

### SUMMARY OF THE INVENTION

It is an object of the invention to provide a shaving unit and a shaving device as described in the section Field of the Invention which do not have the disadvantages of the known shaving units and shaving devices as described here before. In particular, it is an object of the invention to provide a shaving unit and a shaving device as described in the section Field of the Invention wherein the ability of the skin-supporting surfaces and the external cutting members of the hair-cutting units to adapt their orientations to local contours of the skin is further improved with the use of a relatively simple structure.

In order to achieve these objects, according to the invention a shaving unit as described in the section Field of the Invention is characterized in that each hair-cutting unit further comprises a second pivot axis about which the skin-supporting member is pivotable relative to the supporting member independently from the skin-supporting members of the other hair-cutting units, said second pivot axis extending perpendicularly to the first pivot axis of the hair-cutting unit, and a total range of a pivot angle over which the skin-supporting member is pivotable about the second pivot axis being equal to or larger than 15°.

According to the invention, a shaving device as described in the section Field of the Invention is characterized in that the shaving unit used therein is a shaving unit according to the invention.

It will be clear for the person skilled in the art that, in accordance with the invention, the feature “a second pivot axis about which the skin-supporting member is pivotable relative to the supporting member independently from the skin-supporting members of the other hair-cutting units” is to be understood as “a second pivot axis about which the skin-supporting member is pivotable relative to the supporting member independently from any pivoting movement of the skin-supporting member of any of the respective other hair-cutting units about the second pivot axis of the respective other hair-cutting unit”. Similarly, in accordance with the invention, the feature “a first pivot axis about which the skin-supporting member is pivotable relative to the supporting member independently from the skin-supporting members of the other hair-cutting units” is to be understood as “a first pivot axis about which the skin-supporting member is pivotable relative to the supporting member independently from any pivoting movement of the skin-supporting member of any of the respective other hair-cutting units about the first pivot axis of the respective other hair-cutting unit”.

In a shaving unit according to the invention, the skin-supporting member of each hair-cutting unit is pivotable relative to the supporting member, independently from the skin-supporting members of the other hair-cutting units, both about the first pivot axis and about the second pivot axis which extends perpendicularly to the first pivot axis. Because the external cutting member of each hair-cutting unit is usually supported by the surrounding skin-supporting member, also the external cutting member of each hair-cutting unit is pivotable relative to the supporting member, independently from the external cutting members of the other hair-cutting units, about the first and second pivot axes of the respective hair-cutting unit. As a result, the ability of both the skin-supporting surfaces and the external cutting members of the hair-cutting units to adapt their orientations to local contours of the skin is improved, so that the contact between the external cutting members and the skin is always optimal and local pressure peaks between the skin and the external cutting members as well as between the skin and the skin-supporting surfaces are limited to a relatively high degree. The use of the first and second pivot axes in respect of movability of the skin-supporting member limits the complexity of the structure of the shaving unit as compared to known shaving units which have three or more pivot axes per individual hair-cutting unit.

A total range of a pivot angle over which the skin-supporting member is pivotable about the second pivot axis is equal to or larger than 15°. Hence, according to the invention, the use of the second pivot axis involves an actual and significant contribution to improving the above-mentioned ability of both the skin-supporting surfaces and the external cutting members of the hair-cutting units to adapt their orientations to local contours of the skin. For the sake of completeness, assuming a neutral angular position of the skin-supporting member about the second pivot axis achieved by means of, for example, a biasing spring member, it is to be noted that the total pivot angle range of 15° may be composed of a first pivot angle range from the neutral default position in one direction about the second pivot axis and a second pivot angle range from the neutral default position in an opposite direction about the second pivot axis. Both the first pivot angle range and the second pivot angle range may be at least 7.5°, for example. In the framework of the invention, other minimum values of the total range of the pivot angle over which the skin-supporting member is pivotable about the second pivot axis are possible, such as 20°.

In an embodiment of the shaving unit according to the invention, seen in the axial direction relative to the central axis of each respective hair-cutting unit, the second pivot axis of the respective hair-cutting unit extends radially relative to the central axis. As a result, uniformity of skin pressure distribution along the skin-supporting surfaces of the skin-supporting members during pivoting of the skin-supporting members about the second pivot axes is improved.

In a further embodiment of the shaving unit according to the invention, the first pivot axis of each respective hair-cutting unit is arranged, seen in the axial direction relative to the central axis of the respective hair-cutting unit, radially outward of the radially outward circular boundary of the annular cutting path of the respective hair-cutting unit. In this embodiment, the first pivot axis is arranged in a position close to a circumference of the external cutting member. This arrangement of the first pivot axis results in relatively large displacements of the external cutting member and the surrounding skin-supporting surface in positions diametrically opposite to the position of the first pivot axis during pivoting of the skin-supporting member about the first pivot axis, so that the ability of the skin-supporting surface and the external cutting member to adapt their orientations to local contours of the skin is further improved.

In a further embodiment of the shaving unit according to the invention, the supporting member is arranged centrally between the hair-cutting units, and the first pivot axis of each respective hair-cutting unit is arranged, seen in the axial direction relative to the central axis of the respective hair-cutting unit, between the central axis and the supporting member. In this embodiment, the first pivot axis may be arranged in a central area between the hair-cutting units and may be realized by means of a pivot structure which is partially provided on the centrally arranged supporting member. This will result in a compact structure of the shaving unit.

In a further embodiment of the shaving unit according to the invention, the shaving unit comprises three hair-cutting units, and, seen in an axial direction relative to a centre line of the supporting member, the second pivot axis of each respective hair-cutting unit extends radially relative to the centre line. Preferably, in this further embodiment, seen in the axial direction relative to the centre line, the second pivot axes of each pair of adjacent hair-cutting units enclose an angle of 120°. As a result, uniformity of skin pressure distribution along the skin-supporting surfaces of the skin-supporting members during pivoting of the skin-supporting members about the second pivot axes is further improved.

In a further embodiment of the shaving unit according to the invention, each hair-cutting unit further comprises a housing supporting the internal cutting member and the external cutting member of the hair-cutting unit and accommodating an individual hair-collecting chamber of the hair-cutting unit which is separate from the hair-collecting chambers of the other hair-cutting units, wherein the skin-supporting member of each respective hair-cutting unit is connected to the housing of the respective hair-cutting unit, and wherein the housing, the internal cutting member, the external cutting member and the skin-supporting member of each respective hair-cutting unit are together pivotable relative to the supporting member about the first pivot axis and the second pivot axis of the respective hair-cutting unit. In this embodiment, the ability of the skin-supporting members to pivot relative to the supporting member about the first and second pivot axes is achieved in a practical and structurally simple way in that the housing of each respective hair-cutting unit may be connected to the supporting member by means of a pivot structure which defines the first pivot axis and the second pivot axis of the respective hair-cutting unit.

In a further embodiment of the shaving unit according to the invention, the pivot structure of each respective hair-cutting unit comprises a first pivot member provided on the housing of the respective hair-cutting unit, an intermediate body provided with a second pivot member and a third pivot member, and a fourth pivot member provided on the supporting member, wherein the first and second pivot members are arranged in mutual engagement to define the first pivot axis of the respective hair-cutting unit, the housing being pivotable relative to the intermediate body about the first pivot axis, and wherein the third and fourth pivot members are arranged in mutual engagement to define the second pivot axis of the respective hair-cutting unit, the intermediate body being pivotable relative to the supporting member about the second pivot axis. This embodiment results in a compact structure of the shaving unit, wherein the pivot structure of each respective hair-cutting unit may be arranged in a relatively compact space between the supporting member and the respective hair-cutting unit. Preferably, in this further embodiment the first pivot member comprises a pair of bearing recesses and the second pivot member comprises a pair of bearing pins received by the bearing recesses. Preferably, the third pivot member comprises a first cylinder-segment shaped bearing surface, and the fourth pivot member comprises a second cylinder-segment shaped bearing surface arranged to engage with the first cylinder-segment shaped bearing surface.

In a further embodiment of the shaving unit according to the invention, the fourth pivot member comprises:

a first guiding surface provided on a side of the fourth pivot member facing away from the respective hair-cutting unit and extending transversely relative to the second pivot axis; and

a second guiding surface provided on a side of the fourth pivot member facing towards the respective hair-cutting unit and extending transversely relative to the second pivot axis;

and the intermediate body comprises a third guiding surface arranged to engage with the first guiding surface, and a fourth guiding surface arranged to engage with the second guiding surface;
wherein the first and third guiding surfaces are arranged at a first average radial distance from the first pivot axis, and wherein the second and fourth guiding surfaces are arranged at a second average radial distance from the first pivot axis which is larger than the first average radial distance.

The first, second, third and fourth guiding surfaces act to prevent movement of the respective hair-cutting unit relative to the supporting member in a direction in which the second pivot axis extends, and provide a compact and mechanically robust and stable connection of the respective hair-cutting unit to the supporting member via the pivot structure. Since the second and fourth guiding surfaces are arranged at a relatively large average radial distance from the first pivot axis, the second and fourth guiding surfaces are suitable to generate, during use, reaction forces which are sufficiently large to counteract any mechanical torque about the first pivot axis externally exerted on the respective hair-cutting unit. The supporting member and the intermediate body may be provided with further guiding surfaces having similar functionalities as the above-mentioned guiding surfaces.

In a further embodiment of the shaving unit according to the invention, the pivot structure of each respective hair-cutting unit comprises a spring member arranged to bias the intermediate body into a neutral angular position relative to the supporting member about the second pivot axis. Preferably, the spring members of the pivot structures of all hair-cutting units are integrally formed as a single spring unit, for example by suitably cutting and bending a metal sheet.

In a further embodiment of the shaving unit according to the invention, the shaving unit further comprises a drive unit for driving the internal cutting members of the hair-cutting units into rotation about the central axes, wherein the drive unit comprises, for each of the hair-cutting units, an individual drive spindle which is rotationally supported by the supporting member and coupled to the internal cutting member of the respective hair-cutting unit, wherein each drive spindle comprises a spring element arranged to enable the drive spindle to exert a biasing force on the internal cutting member of the respective hair-cutting unit urging the housing of the respective hair-cutting unit into an angular end position relative to the supporting member about the first pivot axis. In said angular end positions of the housings, the skin-supporting surfaces and the external cutting members of all hair-cutting units may together take a concave shape suitable to adapt the shaving unit to a convexly curved portion of the skin. By pivoting of the housings about the first pivot axes against the biasing forces, the skin-supporting surfaces and the external cutting members of all hair-cutting units may together take a flat or convex shape suitable to adapt the shaving unit to a flat or concavely curved portion of the skin. In this further embodiment, each drive spindle may extend through an opening in a bottom wall of the housing of the respective hair-cutting unit in order to engage with the internal cutting member. In addition to or instead of the spring elements comprised by the drive spindles, the pivot structure of each respective hair-cutting unit may comprise a spring element arranged to bias the housing of the respective hair-cutting unit into the angular end position about the first pivot axis.

The above-described and other aspects of the invention will be apparent from and elucidated with reference to the following detailed description of a shaving device and a shaving unit as used in the shaving device.

### BRIEF DESCRIPTION OF THE DRAWINGS

The invention will now be explained in greater detail with reference to the figures, in which equal or similar parts are indicated by the same reference signs, and in which:

FIG. 1 illustrates the general set-up of a shaving device according to the invention;

FIG. 2 diagrammatically shows a top view of a shaving unit according to the invention, which is part of the shaving device according to the invention, and which comprises a supporting member and three hair-cutting units;

FIG. 3 diagrammatically shows separate components of the shaving unit according to the invention;

FIG. 4 diagrammatically shows a perspective view of a housing of a hair-cutting unit of the shaving unit according to the invention;

FIGS. 5, 6 and 7 diagrammatically show different views of an intermediate body of a pivot structure of the hair-cutting unit of the shaving unit according to the invention;

FIG. 8 diagrammatically shows a perspective view of a supporting member of the shaving unit according to the invention;

FIG. 9 illustrates how, in the shaving unit according to the invention, the intermediate body of the pivot structure of the hair-cutting unit engages with the supporting member;

FIG. 10 diagrammatically shows a top view of the supporting member and one hair-cutting unit of the shaving unit according to the invention;

FIG. 11 diagrammatically shows a sectional view of the supporting member and the hair-cutting unit of the shaving unit according to the invention;

FIGS. 12 and 13 diagrammatically show another sectional view of the supporting member and the hair-cutting unit of the shaving unit according to the invention, for two different angular positions of the hair-cutting unit relative to the supporting member about a second pivot axis;

FIG. 14 illustrates an alternative configuration of first and second pivot axes of the hair-cutting units of the shaving unit according to the invention; and

FIG. 15 illustrates a configuration of first and second pivot axes of the hair-cutting units of a shaving unit according to the invention having two hair-cutting units.

### DETAILED DESCRIPTION OF THE EMBODIMENTS

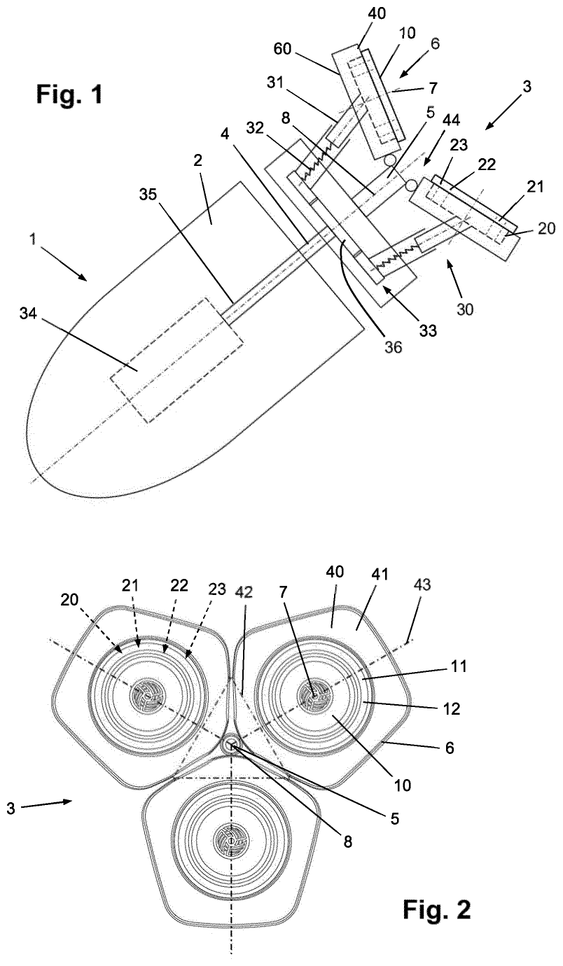

FIG. 1 shows a shaving device 1 according to the invention, which is a shaving device of the rotary type. The shaving device 1 comprises a main housing 2 which is intended to be taken hold of by a user of the shaving device 1, and a shaving unit 3 according to the invention, which is intended to be pressed against an area of skin to be subjected to a hair-cutting action. The main housing 2 of the shaving device 1 is also commonly referred to as body or handle of the shaving device 1. The main housing 2 and the shaving unit 3 are coupled to each other through a coupling 4 which may be adapted to allow movement of the shaving unit 3 relative to the main housing 2 and/or removal of the shaving unit 3 from the main housing 2. The shaving unit 3 comprises a supporting member 5 and at least two hair-cutting units 6 connected to the supporting member 5. When the shaving device 1 is applied for the purpose of subjecting an area of skin to a hair-cutting action, the actual process of cutting off hairs protruding from the skin takes place at the position of the hair-cutting units 6.

The basic hair-cutting functionality of a hair-cutting unit 6 will now be described in more detail, wherein it is noted that FIG. 2 provides a top view of a shaving unit 3 according to the invention comprising the supporting member 5 and three hair-cutting units 6. Throughout the following description, it is assumed that the number of hair-cutting units 6 is three, which does not alter the fact that the invention covers options of the number of hair-cutting units 6 being two or more than three. The following description is equally applicable to another possible number of hair-cutting units 6, and is therefore to be understood so as to involve a disclosure of the invention in respect of other possible numbers of hair-cutting units 6 as well, with the exception of aspects which are inextricably linked to the exemplary number of three.

The hair-cutting unit 6 comprises an external cutting member 10 and an internal cutting member 20. The external cutting member 10 is of a generally cup-shaped design and has a substantially circular periphery, whereby the external cutting member 10 is suitable for at least partially accommodating the internal cutting member 20 in its interior. In the base of the cup-shaped design of the external cutting member 10, an annular cutting track 11 is present, at the position of which the external cutting member 10 has a plurality of hair-entry openings. The internal cutting member 20 is rotatable relative to the external cutting member 10 about a central axis 7 of the hair-cutting unit 6 and comprises a plurality of hair-cutting elements each having a cutting edge in a manner known per se in the field of rotary shaving devices. The rotatable arrangement of the internal cutting member 20 in the hair-cutting unit 6 is such that, during rotation of the internal cutting member 20, the cutting edges of the hair-cutting elements follow an annular cutting path 21 having, relative to the central axis 7, a radially inward circular boundary 22 and a radially outward circular boundary 23, which are indicated in FIG. 1 by means of dashed lines. A radial position of the annular cutting path 21 relative to the central axis 7 corresponds to a radial position of the annular cutting track 11 of the external cutting member 10 relative to the central axis 7.

At the position of the annular cutting track 11, the external cutting member 10 has a cutting track surface 12 for contacting a person's skin during a hair-cutting action. A hair-cutting action can be performed when the internal cutting member 20 of the hair-cutting unit 6 is activated to rotate and an area of skin is actually contacted by the external cutting member 10 through the cutting track surface 12. When the hair-cutting unit 6 is moved over the area of skin, it is achieved that hairs protruding from the skin are caught in the hair-entry openings of the external cutting member 10 and are cut off in that position as result of a cooperation between surfaces delimiting the hair-entry openings and the cutting edges of the rotating internal cutting member 20.

The shaving unit 3 further comprises a drive unit 30 for driving the internal cutting members 20 of the hair-cutting units 6 into rotation about the central axes 7. The drive unit 30 comprises, for each of the hair-cutting units 6, an individual drive spindle 31 which is rotationally supported by the supporting member 5 and coupled to the internal cutting member 20 of the respective hair-cutting unit 6. Each drive spindle 31 comprises a spring element 32 arranged to enable the drive spindle 31 to exert a biasing force on the internal cutting member 20 of the respective hair-cutting unit 6. The drive spindles 31 of the drive unit 30 are coupled to a gear system 33 of the drive unit 30, which gear system 33 is arranged to be driven by a motor 34, arranged in the main housing 2, when the shaving unit 3 is coupled to the main housing 2 by means of the coupling 4. The motor 34 comprises a motor axle 35 which extends from the motor 34 and is coupled to a central driven input axle 36 of the gear system 33. In a general sense, the motor 34 constitutes an electric actuator of the shaving device 1.

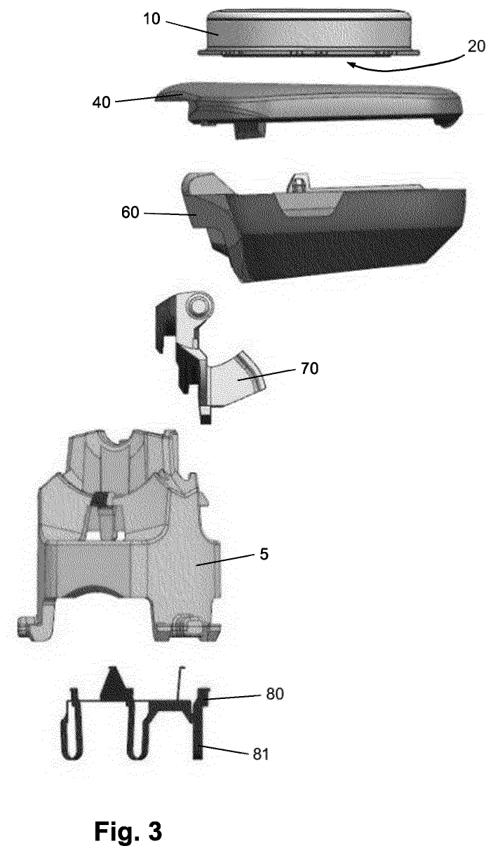

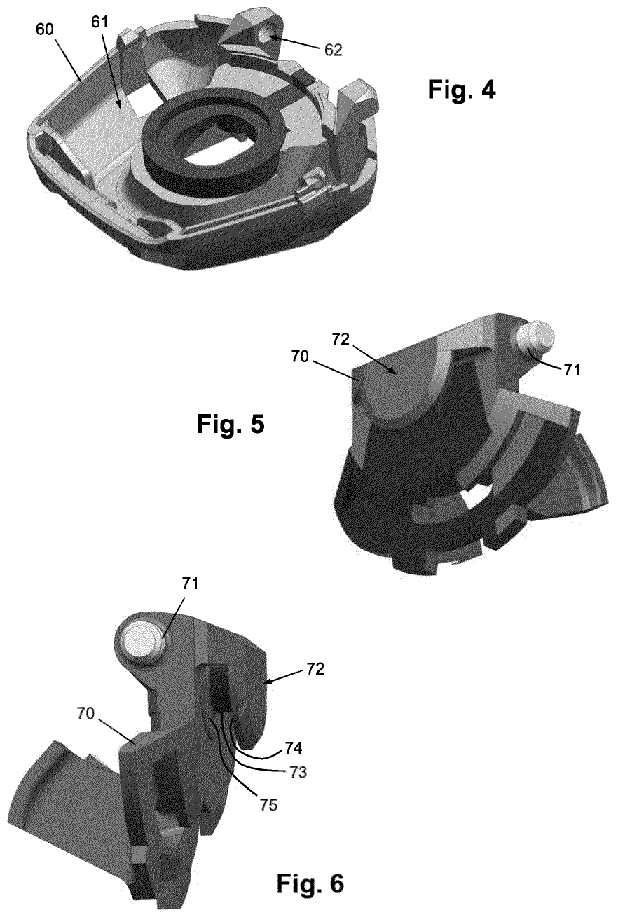

With reference to FIGS. 2 and 3, it is noted that, besides the external cutting member 10 and the internal cutting member 20, the hair-cutting unit 6 comprises a skin-supporting member 40 having a skin-supporting surface 41 at least partially surrounding the external cutting member 10, and further comprises a housing 60 supporting the internal cutting member 20 and the external cutting member 10 of the hair-cutting unit 6 and accommodating a hair-collecting chamber 61 of the hair-cutting unit 6 as can be seen in FIG. 4. The skin-supporting surface 41 of the skin-supporting member 40 serves to contact a portion of skin to be subjected to a hair-cutting action. The hair-collecting chamber 61 of the hair-cutting unit 6 serves for receiving and accommodating hairs which are cut off during a hair-cutting action, and is an individual hair-collecting chamber 61 which is separate from the hair-collecting chambers 61 of the other hair-cutting units 6. The skin-supporting member 40 of each respective hair-cutting unit 6 is connected to the housing 60 of the respective hair-cutting unit 6 by means of an opening and closing mechanism, which is not shown in detail in the figures and which allows the user to open and close the hair-collecting chamber 61, for example, by pivoting the skin-supporting member 40 relative to the housing 60. Thereby, the skin-supporting member 40 serves for sealing the hair-collecting chamber 61 which is present in the housing 60 in an operational, normal condition of the hair-cutting unit 6.

For the purpose of enabling the hair-cutting units 6 to adapt their orientations to local contours of an area of skin to be subjected to a hair-cutting action by means of the shaving unit, so that a high degree of contact between the external cutting members 10 and the skin is achieved and a good result of the shaving process is obtained, it is advantageous if the shaving unit 3 is designed so that at least the skin-supporting members 40 are movable relative to the supporting member 5, at least to a limited extent. In the following, a feasible option covered by the invention in respect of the advantageous movability of at least the skin-supporting members 40 is explained with reference to FIG. 2.

In the first place, in each of the hair-cutting units 6, the skin-supporting member 40 is pivotable relative to the supporting member 5 about a first pivot axis 42, independently of the other hair-cutting units 6, the first pivot axis 42 extending in a tangential direction relative to the central axis 7 of the hair-cutting unit 6 and, seen in an axial direction relative to the central axis 7, being arranged radially outward of the radially inward circular boundary 22 of the annular cutting path 21 followed by the cutting edges of the hair-cutting elements of the internal cutting member 20. In the second place, in each of the hair-cutting units 6, the skin-supporting member 40 is pivotable relative to the supporting member 5 about a second pivot axis 43, independently from the skin-supporting members 40 of the other hair-cutting units 6, said second pivot axis 43 extending perpendicularly to the first pivot axis 42 of the hair-cutting unit 6, and a total range of a pivot angle over which the skin-supporting member 40 is pivotable about the second pivot axis 43 being equal to or larger than 15°.

In the configuration of three hair-cutting units 6 shown in FIG. 2, the second pivot axis 43 of each of the hair-cutting units 6 extends radially relative to the central axis 7 of the respective hair-cutting unit 6, seen in the axial direction relative to the central axis 7. Further, in the said configuration, the first pivot axis 42 of each respective hair-cutting unit 6 is arranged, seen in the axial direction relative to the central axis 7 of the respective hair-cutting unit 6, radially outward of the radially outward circular boundary 23 of the annular cutting path 21 of the respective hair-cutting unit 6. Still further, in the said configuration, the supporting member 5 is at a central position between the hair-cutting units 6, wherein the first pivot axis 42 of each respective hair-cutting unit 6 is arranged, seen in the axial direction relative to the central axis 7 of the respective hair-cutting unit 6, between the central axis 7 and the supporting member 5, and wherein, seen in an axial direction relative to a centre line 8 of the supporting member 5, the second pivot axis 43 of each respective hair-cutting unit 6 extends radially relative to the centre line 8. In particular, seen in the axial direction relative to the centre line 8, the second pivot axes 43 of each pair of adjacent hair-cutting units 6 enclose an angle of 120°.

In the present embodiment of the shaving unit 3 according to the invention, the housing 60, the internal cutting member 20, the external cutting member 10 and the skin-supporting member 40 of each respective hair-cutting unit 6 are together pivotable relative to the supporting member 5 about the first pivot axis 42 and the second pivot axis 43 of the respective hair-cutting unit 6. A pivot structure 44, by means of which the housing 60 of each respective hair-cutting unit 6 is connected to the supporting member 5, defines the first pivot axis 42 and the second pivot axis 43 of the respective hair-cutting unit 6. In particular, the pivot structure 44 of each respective hair-cutting unit 6 comprises i) a first pivot member 62 provided on the housing 60 of the respective hair-cutting unit 6, ii) an intermediate body 70 provided with a second pivot member 71 and a third pivot member 72, and iii) a fourth pivot member 51 provided on the supporting member 5.

With reference to FIGS. 4, 5, 6, 7 and 8, in which the housing 60, the intermediate body 70 and the supporting member 5, respectively, are separately shown, it is noted that in the configuration of the pivot structure 44 mentioned above, the first pivot member 62 and the second pivot member 71 are arranged in mutual engagement to define the first pivot axis 42 of the hair-cutting unit 6, wherein the housing 60 is pivotable relative to the intermediate body 70 about the first pivot axis 42. Further, the third pivot member 72 and the fourth pivot member 51 are arranged in mutual engagement to define the second pivot axis 43 of the hair-cutting unit 6, wherein the intermediate body 70 is pivotable relative to the supporting member 5 about the second pivot axis 43. The intermediate body 70 and the supporting member 5 are provided with designated end stop faces at two sides for defining two end positions of a pivoting movement of the intermediate body 70 relative to the supporting member 5 about the second pivot axis 43. In this respect, it is noted that it is mentioned earlier that a total range of a pivot angle over which the skin-supporting member 40 is pivotable about the second pivot axis 43 is equal to or larger than 15°, hence, large enough to achieve a notable effect of the pivoting movement of the skin-supporting member 40 about said second pivot axis 43. In the shown example, the first pivot member 62 comprises a pair of bearing recesses and the second pivot member 71 comprises a pair of bearing pins received by the bearing recesses. Further, in the shown example, the third pivot member 72 comprises a first cylinder-segment shaped bearing surface 73, and the fourth pivot member 51 comprises a second cylinder-segment shaped bearing surface 52 arranged to engage with the first cylinder-segment shaped bearing surface 73.

With reference to FIGS. 8 and 9, it is noted that the fourth pivot member 51 comprises two guiding surfaces 53, 54, namely a first guiding surface 53 provided on a side of the fourth pivot member 51 facing away from the hair-cutting unit 6 and extending transversely relative to the second pivot axis 43, and a second guiding surface 54 provided on a side of the fourth pivot member 51 facing towards the hair-cutting unit 6 and extending transversely relative to the second pivot axis 43. The intermediate body 70 comprises a third guiding surface 74 arranged to engage with the first guiding surface 53, and a fourth guiding surface 75 arranged to engage with the second guiding surface 54, as can be seen in FIGS. 6, 7 and 9. The first guiding surface 53 and the third guiding surface 74 are arranged at a first average radial distance from the first pivot axis 42, and the second guiding surface 54 and the fourth guiding surface 75 are arranged at a second average radial distance from the first pivot axis 42 which is larger than the first average radial distance. This configuration of the respective guiding surfaces 53, 54, 74, 75 serves to prevent movement of the hair-cutting unit 6 relative to the supporting member 5 in a direction in which the second pivot axis 43 extends and contributes to compactness and mechanical strength of the pivot structure 44.

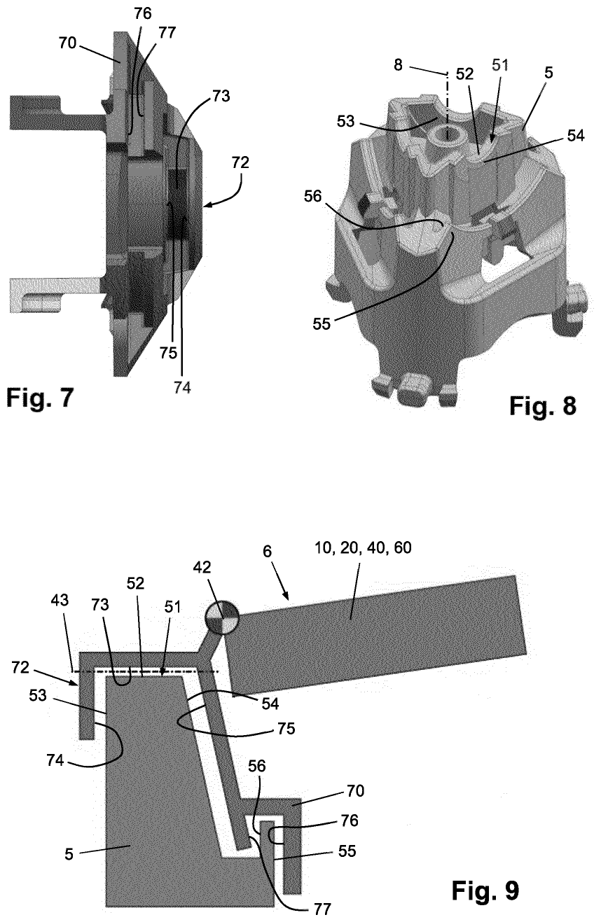

The supporting member 5 and the intermediate body 70 may be provided with further guiding surfaces having similar functionalities as the above-mentioned guiding surfaces 53, 54, 74, 75. With reference to FIGS. 8 and 9, it is noted that in the shown example, the supporting member 5 comprises a fifth guiding surface 55 provided on a side of the supporting member 5 facing towards the respective hair-cutting unit 6 and extending transversely relative to the second pivot axis 43, and a sixth guiding surface 56 provided on a side of the supporting member 5 facing away from the respective hair-cutting unit 6 and extending transversely relative to the second pivot axis 43. Further, with reference to FIGS. 7 and 9, it is noted that in the shown example, the intermediate body 70 comprises a seventh guiding surface 76 arranged to engage with the fifth guiding surface 55, and an eighth guiding surface 77 arranged to engage with the sixth guiding surface 56. The fifth guiding surface 55, the sixth guiding surface 56, the seventh guiding surface 76 and the eighth guiding surface 77 are arranged at a third average radial distance from the first pivot axis 42, which is larger than the first average radial distance and larger than the second average radial distance mentioned here before. As a result of the relatively large third average radial distance, the fifth guiding surface 55, the sixth guiding surface 56, the seventh guiding surface 76 and the eighth guiding surface 77 are suitable to generate, during use, reaction forces which are sufficiently large to counteract any mechanical torque about the first pivot axis 42 externally exerted on the hair-cutting unit 6.

FIG. 3 shows a further component of the pivot structure 44, namely a spring member 80 which is arranged on the supporting member 5 and engages with the intermediate body 70 of each of the hair-cutting units 6 so as to bias the intermediate bodies 70 of the hair-cutting units 6, independently of each other, into a neutral angular position relative to the supporting member 5 about the second pivot axes 43. In the shown example, the spring member 80 includes legs 81 which serve for contacting designated faces of the supporting member 5 and the intermediate body 70 of each of the hair cutting units 6, respectively. Thus, the spring member 80 is integrally formed but, instead, a separate spring member might be provided for each separate intermediate body 70. In a practical embodiment, the spring member 80 may be designed such as to ensure that forces exerted by the spring member 80 are low enough to not be disturbing to the contour following properties associated with the pivotable arrangement of the hair-cutting unit 6 and just high enough to overcome internal friction in the pivot structure 44.

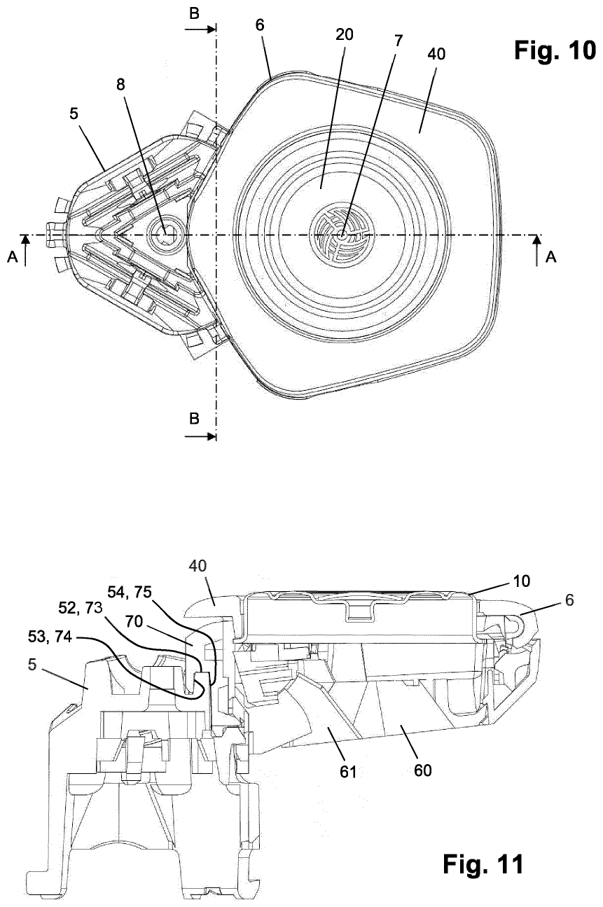

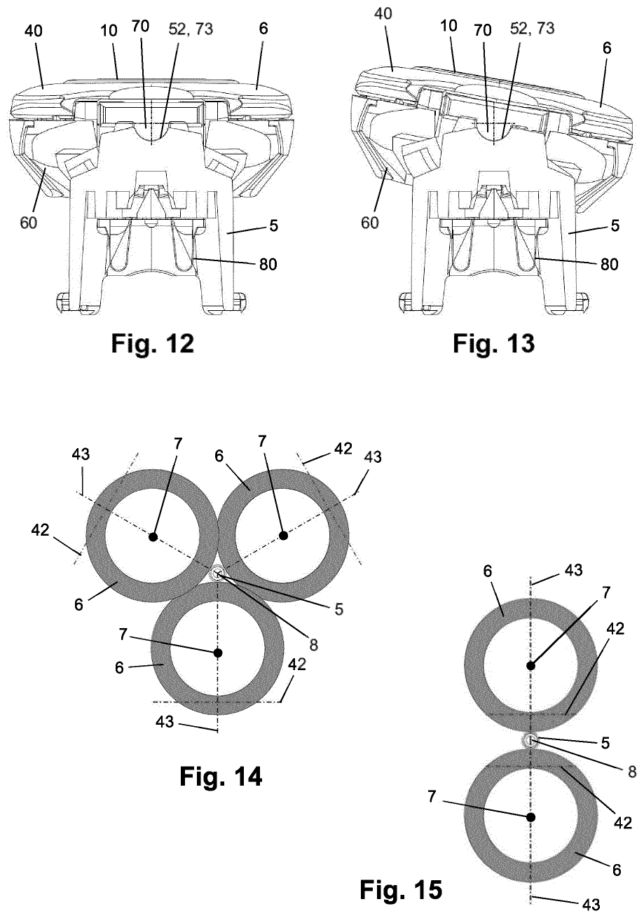

The spring element 32, which is arranged to enable the drive spindle 31 of the hair-cutting unit 6 to exert a biasing force on the internal cutting member 20 of the respective hair-cutting unit 6, has an additional function in urging the housing 60 of the respective hair-cutting unit 6 into an angular end position relative to the supporting member 5 about the first pivot axis 42. It may further be practical to have at least one spring arranged between the respective hair-cutting unit 6 and the intermediate body 70 for performing the same function. The angular end position of the housing 60 relative to the supporting member 5 about the first pivot axis 42 is illustrated in FIG. 11, which shows a side view of a section A-A taken in FIG. 10. The neutral angular position of the intermediate body 70 relative to the supporting member 5 about the second pivot axis 43 and the associated angular position of the housing 60 relative to the supporting member 5 about the second pivot axis 43 is illustrated in FIG. 12, which shows a side view of a section B-B taken in FIG. 10, while a pivoted position of the intermediate body 70 relative to the supporting member 5 about the second pivot axis 43 and the associated angular position of the housing 60 relative to the supporting member 5 about the second pivot axis 43 is illustrated in FIG. 13, which shows the same side view of the section B-B taken in FIG. 10 as FIG. 12.

FIG. 14 provides an illustration of the fact that alternative configurations of the first and second pivot axes 42, 43 are possible in the framework of the invention. In particular, FIG. 14 illustrates an alternative configuration of the respective first pivot axes 42 in the shaving unit 3 comprising three hair-cutting units 6, in which the first pivot axis 42 of each of the hair-cutting units 6 extends at a position relative to the central axis 7 of the respective hair-cutting unit 6 which is both parallel to the position illustrated in FIG. 2 and mirrored to that position about the central axis 7, i.e. more to an outside circumference of the shaving unit 3.

FIG. 15 illustrates a configuration of first and second pivot axes 42, 43 of the hair-cutting units 6 of a shaving unit 3 according to the invention having two hair-cutting units 6. In the shown example, the two hair cutting-units 6 are arranged in a mirror-symmetrical fashion at opposite sides of the supporting member 5. The first pivot axis 42 of each of the hair-cutting units 6 extends at the same position relative to the central axis 7 of the respective hair-cutting unit 6 as the position illustrated in FIG. 2. The second pivot axis 43 of the one hair-cutting unit 6 is aligned with the second pivot axis 43 of the other hair-cutting unit 6, without the second pivot axes 43 being coupled to each other, that is to say, without the pivoting movement of at least the skin-supporting member 40 of the one hair-cutting unit 6 about the second pivot axis 43 of that one hair-cutting unit 6 being dependent on the pivoting movement of at least the skin-supporting member 40 of the other hair-cutting unit 6 about the second pivot axis 43 of that other hair-cutting unit 6.

Independent of the exact details of embodiments, by having a configuration which is suitable for allowing the skin-supporting member 40 of a hair-cutting unit 6 to pivot about both a first pivot axis 42 and a second pivot axis 43 as defined and explained in the foregoing, improved shaving results are obtained due to improved ability of the skin-supporting surface 41 and especially the external cutting member 10 which is at least partially surrounded by the skin-supporting surface 41 to adapt their orientations to local contours of the skin during a hair-cutting action, wherein there is no need to take complex measures.

It will be clear to a person skilled in the art that the scope of the invention is not limited to the examples discussed in the foregoing, but that several amendments and modifications thereof are possible without deviating from the scope of the invention as defined in the attached claims. It is intended that the invention be construed as including all such amendments and modifications insofar they come within the scope of the claims or the equivalents thereof. While the invention has been illustrated and described in detail in the figures and the description, such illustration and description are to be considered illustrative or exemplary only, and not restrictive. The invention is not limited to the disclosed embodiments. The drawings are schematic, wherein details which are not required for understanding the invention may have been omitted, and not necessarily to scale.

Variations to the disclosed embodiments can be understood and effected by a person skilled in the art in practicing the claimed invention, from a study of the figures, the description and the attached claims. In the claims, the word “comprising” does not exclude other steps or elements, and the indefinite article “a” or “an” does not exclude a plurality. Any reference signs in the claims should not be construed as limiting the scope of the invention.

Elements and aspects discussed for or in relation with a particular embodiment may be suitably combined with elements and aspects of other embodiments, unless explicitly stated otherwise. Thus, the mere fact that certain measures are recited in mutually different dependent claims does not indicate that a combination of these measures cannot be used to advantage.

The terms “comprise” and “include” as used in this text will be understood by a person skilled in the art as covering the term “consist of”. Hence, the term “comprise” or “include” may in respect of an embodiment mean “consist of”, but may in another embodiment mean “contain/have/be equipped with at least the defined species and optionally one or more other species”.

Notable aspects of the invention are summarized as follows. A shaving unit 3 for use in a shaving device 1 comprises a supporting member 5 and at least two hair-cutting units 6 connected to the supporting member 5, wherein each hair-cutting unit 6 comprises an external cutting member 10, a skin-supporting member 40 having a skin-supporting surface 41 at least partially surrounding the external cutting member 10, and an internal cutting member 20. Further, in each of the hair-cutting units 6, the skin-supporting member 40 is pivotable relative to the supporting member 5 about both a first pivot axis 42 and a second pivot axis 43, independently from the skin-supporting members 40 of the other hair-cutting units 6, wherein the first and second pivot axes 42, 43 of each respective hair-cutting unit 6 are perpendicular relative to each other, and wherein a total range of a pivot angle over which the skin-supporting member 40 of each hair-cutting unit 6 is pivotable about the second pivot axis 43 is equal to or larger than 15°.

1. A shaving unit for use in a shaving device, the shaving unit comprising a supporting member and at least two hair-cutting units connected to the supporting member, wherein each hair-cutting unit comprises:
an external cutting member having a plurality of hair-entry openings;
a skin-supporting member having a skin-supporting surface at least partially surrounding the external cutting member;
an internal cutting member which is rotatable relative to the external cutting member about a central axis of the hair-cutting unit and comprises a plurality of hair-cutting elements each having a cutting edge, wherein during rotation of the internal cutting member the cutting edges of the hair-cutting elements follow an annular cutting path having, relative to the central axis, a radially inward circular boundary and a radially outward circular boundary;
a first pivot axis about which the skin-supporting member is pivotable relative to the supporting member independently from skin-supporting members of other hair-cutting units in the shaving device, said first pivot axis extending in a tangential direction relative to the central axis and, seen in an axial direction relative to the central axis, being arranged radially outward of the radially inward circular boundary of the annular cutting path; and
a second pivot axis about which the skin-supporting member is pivotable relative to the supporting member independently from the skin-supporting members of the other hair-cutting units in the shaving device, said second pivot axis extending perpendicularly to the first pivot axis of the hair-cutting unit, wherein a total range of a pivot angle over which the skin-supporting member is pivotable about the second pivot axis is equal to or larger than 15°.

2. The shaving unit as claimed in claim 1, wherein, seen in the axial direction relative to the central axis of each respective hair-cutting unit, the second pivot axis of the respective hair-cutting unit extends radially relative to the central axis.

3. The shaving unit as claimed in claim 1, wherein the first pivot axis of each respective hair-cutting unit is arranged, seen in the axial direction relative to the central axis of the respective hair-cutting unit, radially outward of the radially outward circular boundary of the annular cutting path of the respective hair-cutting unit.

4. The shaving unit as claimed in claim 1, wherein the supporting member is arranged centrally between the hair-cutting units, and wherein the first pivot axis of each respective hair-cutting unit is arranged, seen in the axial direction relative to the central axis of the respective hair-cutting unit, between the central axis and the supporting member.

5. The shaving unit as claimed in claim 4, wherein the shaving unit comprises three hair-cutting units, and wherein, seen in an axial direction relative to a center line of the supporting member, the second pivot axis of the each respective hair-cutting unit extends radially relative to the center line.

6. The shaving unit as claimed in claim 5, wherein, seen in the axial direction relative to the center line, the second pivot axes of each pair of adjacent hair-cutting units enclose an angle of 120°.

7. The shaving unit as claimed in claim 1, wherein the each hair-cutting unit further comprises a housing supporting the internal cutting member and the external cutting member of the hair-cutting unit and accommodating an individual hair-collecting chamber of the hair-cutting unit which is separate from hair-collecting chambers of the other hair-cutting units, wherein the skin-supporting member of each respective hair-cutting unit is connected to the housing of the respective hair-cutting unit, and wherein the housing, the internal cutting member, the external cutting member and the skin-supporting member of the each respective hair-cutting unit are together pivotable relative to the supporting member about the first pivot axis and the second pivot axis of the respective hair-cutting unit.

8. The shaving unit as claimed in claim 7, wherein the housing of the each respective hair-cutting unit is connected to the supporting member by means of a pivot structure which defines the first pivot axis and the second pivot axis of the respective hair-cutting unit.

9. The shaving unit as claimed in claim 8, wherein the pivot structure of the each respective hair-cutting unit comprises:
a first pivot member provided on the housing of the respective hair-cutting unit;
an intermediate body provided with a second pivot member and a third pivot member; and
a fourth pivot member provided on the supporting member;
wherein:
the first and second pivot members are arranged in mutual engagement to define the first pivot axis of the respective hair-cutting unit, the housing being pivotable relative to the intermediate body about the first pivot axis; and
the third and fourth pivot members are arranged in mutual engagement to define the second pivot axis of the respective hair-cutting unit, the intermediate body being pivotable relative to the supporting member about the second pivot axis.

10. The shaving unit as claimed in claim 9, wherein the first pivot member comprises a pair of bearing recesses and the second pivot member comprises a pair of bearing pins received by the bearing recesses.

11. The shaving unit as claimed in claim 9, wherein the third pivot member comprises a first cylinder-segment shaped bearing surface, and wherein the fourth pivot member comprises a second cylinder-segment shaped bearing surface arranged to engage with the first cylinder-segment shaped bearing surface.

12. The shaving unit as claimed in claim 11, wherein the fourth pivot member comprises:
a first guiding surface provided on a side of the fourth pivot member facing away from the respective hair-cutting unit and extending transversely relative to the second pivot axis; and
a second guiding surface provided on a side of the fourth pivot member facing towards the respective hair-cutting unit and extending transversely relative to the second pivot axis;
wherein the intermediate body comprises a third guiding surface arranged to engage with the first guiding surface, and a fourth guiding surface arranged to engage with the second guiding surface;
wherein the first and third guiding surfaces are arranged at a first average radial distance from the first pivot axis, wherein the second and fourth guiding surfaces are arranged at a second average radial distance from the first pivot axis, and wherein the first average radial distance is larger than the first average radial distance.

13. The shaving unit as claimed in claim 9, wherein the pivot structure of each respective hair-cutting unit comprises a spring member arranged to bias the intermediate body into a neutral angular position relative to the supporting member about the second pivot axis.

14. The shaving unit as claimed in claim 7, further comprising a drive unit for driving the internal cutting members of the hair-cutting units into rotation about the central axes, wherein the drive unit comprises, for the each hair-cutting unit, an individual drive spindle which is rotationally supported by the supporting member and coupled to the internal cutting member of the respective hair-cutting unit, wherein each drive spindle comprises a spring element arranged to enable the drive spindle to exert a biasing force on the internal cutting member of the respective hair-cutting unit urging the housing of the respective hair-cutting unit into an angular end position relative to the supporting member about the first pivot axis.

15. A shaving device comprising:
a main housing accommodating an electric actuator;
a shaving unit as claimed in claim 1 coupled to the main housing.
